(19) United States
(12) Patent Application Publication
(10) Pub. No.: US 2024/0424570 A1
(43) Pub. Date: Dec. 26, 2024

(54) METHOD AND APPARATUS FOR POWDER MATERIAL HANDLING IN ADDITIVE MANUFACTURING

(71) Applicant: VulcanForms Inc., Burlington, MA (US)

(72) Inventors: Lucas BUERMEYER, Ayer, MA (US); William Curtis STONE, Tewksbury, MA (US)

(73) Assignee: VulcanForms Inc., Burlington, MA (US)

(21) Appl. No.: 18/746,737

(22) Filed: Jun. 18, 2024

Related U.S. Application Data
(60) Provisional application No. 63/510,179, filed on Jun. 26, 2023.

(51) Int. Cl. B22F 12/52; B22F 12/57; B22F 12/90; B33Y 10/00; B33Y 30/00

(52) U.S. Cl. CPC B22F 12/52; B22F 12/57; B22F 12/90; B22F 2201/10; B33Y 10/00; B33Y 30/00

(57) ABSTRACT

System and method for dispensing powder material for an additive manufacturing system. A preload container can be configured to hold a predetermined amount of powder material, and move the powder material from a powder supply to a powder recoater. The preload container may be configured to hold an amount of powder suitable for forming multiple powder layers on a build surface and may be configured to rapidly deliver the powder material to a powder recoater, e.g., in less than 10 seconds. The powder material in the preload container and/or the powder supply may be maintained in an isolated environment, e.g., during transfer of powder material from the powder supply to the preload container. A seal may have a movable portion configured to interface between the powder supply and a recoater hopper.

### RELATED APPLICATIONS

This application claims priority under 35 U.S.C. § 119 (e) to U.S. Provisional Application No. 63/510,179, filed Jun. 26, 2023, the content of which is incorporated by reference in its entirety for all purposes.

### FIELD

Disclosed embodiments are generally related to systems and methods for handling powder material, e.g., for use in additive manufacturing systems.

### BACKGROUND

Additive manufacturing systems employ various techniques to create three-dimensional objects from two-dimensional layers. In some cases, after a layer of precursor material is deposited onto a build surface, a portion of the layer may be fused through exposure to one or more energy sources to create a desired two-dimensional geometry of solidified material within the layer. Next, the build surface may be indexed, e.g., moved downwardly, and another layer of precursor material may be deposited over the prior layer and areas selectively fused. For example, in some systems the build surface may be indexed downwardly by a distance corresponding to a thickness of a layer, precursor material may be deposited to a desired thickness and then selected portions of the newly deposited layer fused. This process may be repeated layer-by-layer to fuse many two-dimensional layers together to form a three-dimensional object.

### SUMMARY

Recoater systems may be employed in additive manufacturing systems to deposit the needed layers of powder material for an additive manufacturing process. For example, a recoater hopper may be used to deposit powder material in controlled amounts so that a suitably thick or otherwise arranged layer of powder material is formed on a build surface. Periodically, a recoater hopper must be refilled or otherwise provided with powder material since some manufacturing processes may require relatively large volumes and/or masses of powder material and a recoater hopper may not be capable of holding the entire amount at one time. The inventors have appreciated that in some cases refilling of a recoater hopper may take unsuitably long periods of time, particularly if a closely controlled amount of powder material is to be provided to the recoater hopper. Such delay may increase part manufacturing times.

In some cases, the inventors have developed methods and systems for accurately and/or rapidly delivering powder material to a recoater system. In some embodiments, a system for dispensing a powder material for an additive manufacturing system includes a powder supply configured to hold the powder material, e.g., a hopper may hold powder material and have a funnel-shaped or tapered portion leading to an outlet of the hopper. A preload container may be coupled to the powder supply, e.g., to an outlet of the powder supply, and configured to hold a predetermined amount of powder material received from the powder supply. For example, the preload container may be configured to hold or otherwise be provided with a predetermined volume and/or mass of powder material. The predetermined amount of powder material may be suitable for a recoater hopper to form multiple layers of powder material on a build surface of the additive manufacturing system, such as 10, 20, 30 or more layers. A mechanism may be configured to control a flow of the predetermined amount of powder material from the preload container to a recoater hopper of a recoater system. For example, a valve may be configured to be opened to permit the powder material to fall by gravity from the preload container to the recoater hopper. In some cases, the preload container and the mechanism may be configured to deliver the entire predetermined amount of powder material to the recoater hopper such that the preload container is emptied of powder material. Such an arrangement may allow for refilling or other provision of powder material to a recoater hopper in a relatively rapid way and/or may allow for delivery of a relatively accurate volume and/or mass of powder material to the recoater hopper without having to measure or otherwise closely control the delivery from the preload container to the recoater hopper. Instead, the preload container may first be accurately provided with a predetermined volume and/or mass of powder material, and then the predetermined volume and/or mass emptied from the preload container to the recoater hopper. In some cases, the transfer of the entire volume and/or mass of powder material from the preload container to the recoater hopper may be completed in 10 seconds or less.

In some cases, a sensor may be configured to detect when the preload container holds the predetermined amount of powder material in the preload container. For example, a sensor may be configured to optically or otherwise detect that the preload container holds the predetermined amount of powder material and/or configured to detect a mass of powder material in the preload container. For example, a sensor may detect a weight of powder material provided from the powder supply to the preload container, e.g., by detecting a change in weight of the powder supply and/or the preload container. In some cases, a sensor may detect the powder material has reached a particular fill level in the preload container or other level in the powder supply and a determination may be made that the predetermined amount of powder material has been provided to the preload container.

In some cases, the powder supply may include a hopper positioned vertically above and fluidly coupled to the preload container. For example, the hopper may be configured to deliver the powder material to the preload container via gravity. e.g., in response to opening of a valve between the hopper and the preload container.

In some embodiments, the preload container may have a tubular shape, e.g., including a cylindrical or other tube having an interior volume that is equal to or greater than the predetermined volume of powder material. In some examples, the preload container may include an elongated tube with a longitudinal axis that holds the predetermined amount of powder material, and the longitudinal axis may be oriented at an angle of 45 degrees or less from a vertical axis. Such an orientation of the preload container may enable delivery by gravity of powder material into and/or from the preload container by gravity, e.g., solely by gravity.

In some cases, a controller may be configured to determine that the preload container holds the predetermined amount of powder material based on a volume of powder material in the preload container or a weight of powder material in the preload container. For example, the controller may include a sensor to detect a weight and/or change in weight of the powder supply and/or the preload container to determine a weight of powder material held by the preload container. In some cases, the controller may include a sensor to optically, capacitively or otherwise detect when a level of powder material in the preload container reaches a threshold level.

In some embodiments, a method of dispensing powder material for an additive manufacturing system includes filling a preload container with a predetermined amount of powder material from a powder supply, and transferring the predetermined amount of powder material from the preload container to a recoater hopper such that the preload container is emptied of powder material. In some cases, filling the preload container includes providing the powder material from the powder supply to the preload container until the preload container holds a predetermined volume or mass of powder material. For example, filling the preload container may include using a sensor to measure a volume or mass of powder material in the preload container and stopping providing the powder material from the powder supply to the preload container when the volume or mass of powder is equal to a predetermined volume or mass of powder material. In some cases, filling the preload container includes permitting the powder material to fall under the force of gravity into the preload container, e.g., from a powder supply hopper or other source. In some embodiments, a valve positioned at an entrance to the preload container may be opened to permit the powder material to fall into the preload container during filling.

In some cases, filling the preload container includes moving the predetermined amount of powder material from a powder supply to the preload container while the predetermined amount of powder material is held in an isolated environment, e.g., while a space in which the powder material is located is purged with inert gas.

In some embodiments, transferring the powder material from the preload container comprises transferring the powder material to the recoater hopper solely under the force of gravity. For example, a valve may be opened to permit the predetermined amount of powder material to fall from the preload container and into the recoater hopper under the force of gravity. In some cases, transferring the powder material from the preload container includes emptying the preload container of the predetermined amount of powder material in less than 10 seconds. Transfer of powder material from the preload container to the recoater hopper may be done without releasing any of the predetermined amount of powder material into an environment around the preload container and the recoater hopper. For example, an outlet of the preload container may be in sealingly coupled with an inlet of the recoater hopper.

In some embodiments, a system for dispensing a powder material for an additive manufacturing system includes a powder supply holding the powder material and a preload container coupled to the powder supply. The powder supply and the preload container may be configured to transfer powder material from the powder supply to the preload container in an isolated environment, e.g., while the powder material remains in an environment purged with inert gas. In some cases, a gas purge mechanism may be configured to provide a purging gas into the preload container and the powder supply. For example, the gas purge mechanism may include a gas inlet coupled between the preload container and the powder supply. In some cases, the gas inlet may be positioned below a powder material level in the powder supply. In some embodiments, the powder supply may be configured to hold the powder material in the powder supply such that purging gas entering through the gas inlet passes through the powder material in the powder supply, e.g., so a fluidized bed of powder material is formed with the purging gas.

In some examples, a valve may be employed to control movement of powder material from the powder supply to the preload container, and the gas inlet may be positioned between the valve and the powder supply. A gas outlet may be coupled to the powder supply above a powder material level in the powder supply or elsewhere to provide suitable purging performance.

In some embodiments, a method of dispensing powder material includes providing powder material in an isolated environment within a powder supply, transferring the powder material from the powder supply to a preload container, and maintaining the powder material within the isolated environment during transfer of the powder material to the preload container. For example, providing the powder material in the isolated environment may include purging the powder supply and/or preload container with an inert gas. In some embodiments, transferring the powder material includes opening a pathway between the powder supply and the preload container to permit the powder material to move to the preload container, e.g., by gravity in whole or in part. For example, a valve fluidly coupled between the powder supply and the preload container may be opened to permit powder material to fall solely by gravity into the preload container. In some cases, an inert gas may be provided into a closed space between the valve and the powder supply, e.g., at a location below an upper level of powder material in the powder supply. In some embodiments, a pathway between the powder supply and the preload container may be closed after transferring the powder material to the preload container, and the powder material may be transferred from the preload container to a recoater hopper by emptying the preload container of powder material.

In some embodiments, a system for dispensing a powder material for an additive manufacturing system includes a powder supply holding the powder material and comprising a powder outlet, a recoater hopper having a powder inlet configured to receive the powder material from the powder outlet, and a seal configured to interface between the powder inlet and the powder outlet or otherwise provide a sealed coupling between the inlet and outlet. In some cases, the seal may be configured to permit the recoater hopper and the powder inlet to be moved from a refill position at which the powder outlet and powder inlet are sealingly coupled by the seal to a position away from the powder supply and the powder outlet. The seal may be configured to provide suitable sealing coupling of the powder outlet and the powder inlet when the recoater hopper is moved back to the refill position, e.g., so powder material can be transferred to the recoater hopper without releasing powder material at an interface between the powder outlet and the powder inlet. In some cases, the seal may include a movable portion configured to move to engage with the powder inlet or the powder outlet to provide a fluid connection between the powder inlet and the powder outlet, e.g., a sealed fluid connection.

In some embodiments, a shape of the movable portion of the seal may be changeable, e.g., the movable portion may include a resilient gasket or other resilient component that can change in shape, e.g., to conform to a portion of the powder inlet and/or powder outlet. In some cases, the movable portion may include an inflatable portion that includes a flexible wall and can change shape, e.g., in response to inflation and/or deflation. The inflatable portion may permit the seal to conform to a powder inlet and/or outlet portion and/or provide a resilient bias against the inlet and/or outlet to provide a suitable sealing coupling. In some cases, the seal may include at least one actuator coupled to the moveable portion that is configured to urge the moveable portion into contact with the powder outlet or the powder inlet. In some embodiments, the at least one actuator may extend the moveable portion in a direction from the powder outlet toward the powder inlet, or from the powder inlet toward the powder outlet. In some cases, the seal may be configured to disengage from the powder inlet or the powder outlet such that the recoater hopper can move relative to the powder outlet, e.g., from a refill position to a position away from the refill position. In some examples, the moveable portion may have a shape to conform to at least a part of the powder outlet and/or the powder inlet, e.g., a resilient gasket or other component may provide a conforming engagement to a part of the inlet and/or outlet.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

Other advantages and novel features of the present disclosure will become apparent from the following detailed description of various non-limiting embodiments of the disclosure when considered in conjunction with the accompanying figures.

### BRIEF DESCRIPTION OF DRAWINGS

In the drawings, each identical or nearly identical component that is illustrated in various figures may be represented by a like numeral. For purposes of clarity, not every component may be labeled in every drawing. In the drawings:

FIG. 1 shows a schematic representation of an additive manufacturing system, according to some embodiments;

FIG. 2A shows a side view of a powder supply system, according to some embodiments;

FIG. 2B shows a second side view of the powder hopper of FIG. 2A;

FIG. 3A shows a perspective view of a portion of a preload container, according to some embodiments;

FIG. 3B shows a top view of the preload container portion of FIG. 3A;

FIG. 4 shows a top perspective view of a seal having a movable portion, according to some embodiments;

FIG. 5 shows a bottom perspective view of the seal of FIG. 4;

FIG. 6 shows a side perspective view of the seal of FIG. 4; and

FIG. 7 shows a side perspective view of the seal of FIG. 4 in an extended configuration.

### DETAILED DESCRIPTION

It should be understood that aspects of the disclosure are described herein with reference to the figures, which show illustrative embodiments. The illustrative embodiments described herein are not necessarily intended to show all aspects of the disclosure, but rather are used to describe a few illustrative embodiments. Thus, aspects of the disclosure are not intended to be construed narrowly in view of the illustrative embodiments. In addition, it should be understood that inventive features may be used alone or in any suitable combination with other inventive features. For example, embodiments are described below in which powder material may be transferred from a preload container to a recoater hopper, in which one or more portions of a powder supply system can be purged with inert gas, in which a seal may engage between an outlet of a powder supply and an inlet of a recoater hopper, and others. Any one of these features can be employed with any one or more of the other features, at least to the extent they are not mutually exclusive. Thus, the fact that a single embodiment may not be shown in the figures including various combinations of inventive features should not be interpreted as indicating embodiments are limited to specific combinations of features. To the contrary, any suitable combination of features describe herein may be combined together, or not, in any suitable way.

With the advancement of additive manufacturing systems, increased demands have been placed on every part of the system. Additive manufacturing systems have gotten faster, larger, and more intricate, and there exists an increasing need to maintain precision, quality, and efficiency without sacrificing other aspects of the system. One of the components in need of improvement is the powder supply system, which provides powder material for depositing on a build surface of the additive manufacturing system. Large additive manufacturing systems can use up to thousands of kilograms of powder material for a single printed part, thus requiring efficient movement of the powder material to reduce part formation times. Also, powder material, especially metallic powders, can cause dust fires or otherwise create potentially explosive conditions if handled improperly and/or can cause deposition of the powder on unwanted areas of the build surface and/or system components, e.g., if the powder material is aerosolized or otherwise released to form a cloud. The inventors have recognized these problems and a need for a powder supply for an additive manufacturing system that can provide accurate and/or rapid delivery of powder material, e.g., to a recoater system for forming multiple layers of powder material on a build surface. Also, powder supply systems that can eliminate or otherwise reduce the unwanted release of powder material, e.g., in dust or aerosol form, can enhance part accuracy and/or system operation.

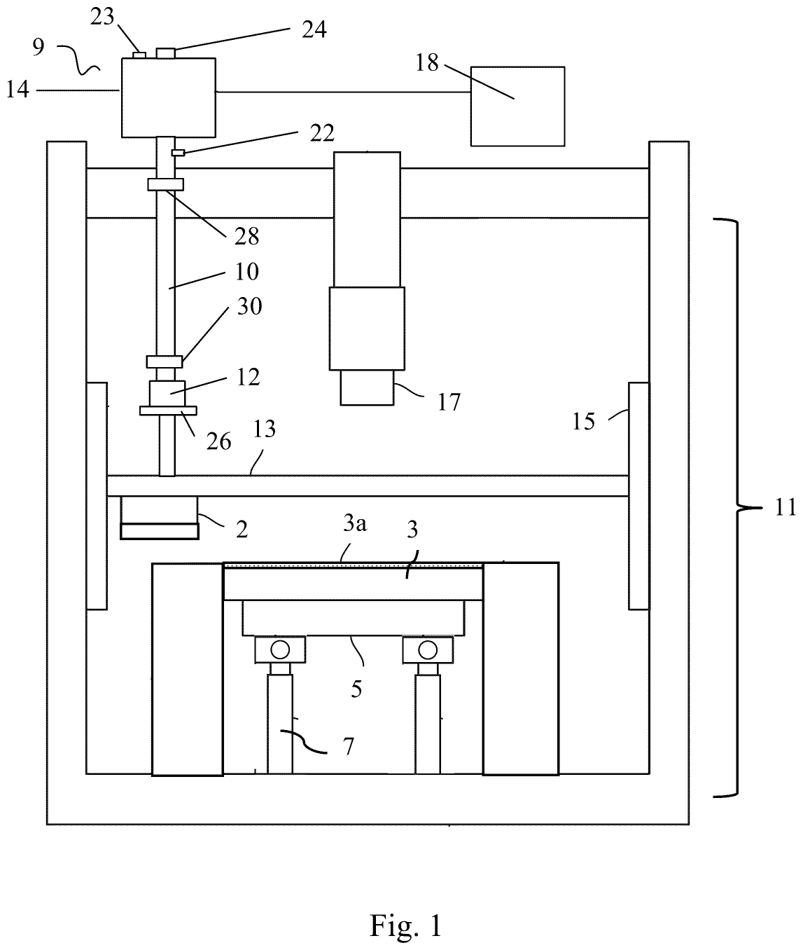

In some embodiments, such as that in FIG. 1, an additive manufacturing system 11 may include a build plate 3 mounted on a base 5, which is in turn mounted on one or more vertical supports 7. The one or more vertical supports 7 can include any appropriate number of supports configured to support the build plate 3, and the corresponding build surface, at a desired position and/or orientation. For example, the supports 7 may include one or more actuators configured to control a vertical position and/or orientation of the build plate 3. In some embodiments, the additive manufacturing system may also include an optics assembly 17 that is supported vertically above and oriented to direct laser energy towards the build plate 3. The optics assembly 17 may be optically coupled to one or more laser energy sources, not depicted, to direct laser energy in the form of one or more laser energy pixels onto the build surface of the build plate 3 to selectively melt powder material on the build surface. To facilitate movement of the laser energy pixels across the build surface, the optics assembly 17 may be configured to move in one, two, or any number of directions relative to the build surface of the build plate. To provide this functionality, the optics assembly 17 may be mounted on a gantry, or other actuated structure, that allows the optics unit to be scanned in a plane parallel to the build surface of the build plate 3.

The laser energy may be used to fuse precursor material 3a, such as a powdered metal material, in selected areas on the build surface to create a desired shape of fused material on the build surface. To provide the precursor material 3a on the build surface, the additive manufacturing system may include a recoater system that includes a recoater hopper 2 mounted on a horizontal motion stage 13 that allows the recoater hopper 2 to be moved across either a portion, or the entire, build surface of the build plate 3. As the recoater hopper 2 traverses the build surface of the build plate 3, the recoater hopper 2 may deposit and/or smooth the precursor material 3a, such as a powder material, on the build plate to provide a layer of precursor material with a predetermined thickness on top of the underlying volume of fused and/or unfused precursor material deposited during prior formation steps. Smoothing of the powder layer may be done by a recoater blade and/or an electrostatic recoater, as is known in the art. The recoater hopper 2 may be moved vertically relative to the build plate 3 by a vertical motion stage 15, e.g., to provide subsequent layers of precursor material 3a on the build surface as a part is built. Alternately, the supports 7 may move the build plate 3 downwardly for each deposited layer of precursor material 3a and the recoater hopper 2 may remain vertically stationary.

In some embodiments, the vertical motion stages, horizontal motion stages, and/or gantry may include any appropriate type of system configured to provide the desired vertical and/or horizontal motion. This may include supporting structures such as: rails; linear bearings, wheels, threaded shafts, and/or any other appropriate structure capable of supporting the various components during the desired movement. Movement of the components may also be provided using any appropriate type of actuator including, but not limited to, electric motors, stepper motors, hydraulic actuators, pneumatic actuators, electric actuators, and/or any other appropriate type of actuator as the disclosure is not so limited. Operation of the various components of the additive manufacturing system 11 can be controlled by a controller 18, which may receive information from and/or provide control signals to any one of the system components including components of the optics assembly 17, motion stages 13, 15, actuators 7, and others.

In some embodiments, an additive manufacturing system may include components to accurately and/or rapidly provide powder material to a recoater hopper or other system components. In at least some respects, printing a part on a build surface 3 may be limited by time needed to deposit layers of powder material on the build surface 3. For example, a build surface 3 may be relatively large, requiring a recoater hopper 2 to travel long distances when depositing powder material across the build surface. Also, the recoater hopper 2 typically must deposit the layers of powder material in a highly accurate way, e.g., having a specified thickness and/or mass of powder material per area on the build surface, which may take time. To help speed operations and reduce the powder layer deposition time, a powder supply system may be configured to deliver powder material, including relatively large amounts of powder material, to the recoater hopper 2 in rapid fashion and with an accurate mass and/or volume. For example, in some cases an amount of powder needed to form 10 to 30 layers or more may be delivered from the powder supply to the recoater hopper 2 in 10 seconds or less. This may enable the recoater hopper 2 to spend relatively little time being loaded with powder material, freeing additional time for layer deposition. Also, the recoater hopper 2 may be loaded with an accurate volume of powder, enabling the recoater hopper 2 to reliably form a known number of powder layers for each charge of powder delivered to the hopper 2 in a refill operation.

In some embodiments, the additive manufacturing system 11 may include a powder supply system 9 configured to supply powder material to a recoater hopper 2. The powder supply system 9 may include a powder supply 14 including a hopper or other container configured to receive and hold relatively large amounts of powder material, such as an amount of powder suitable to fill a recoater hopper 2 one or more times, e.g., 2 to 5 times or more. Powder material may be provided to an inlet of the powder supply 14, e.g., by pneumatic delivery, auger delivery, conveyor or any other suitable mechanism. An outlet of the powder supply 14 may be fluidly coupled to a preload container 10, which may include an elongated tubular portion with a longitudinal axis that is generally aligned along local gravitational field lines. The preload container 10 may be positioned below the powder supply 14 so that powder material can fall under the force of gravity into the preload container 10, though this is not required. A supply mechanism 28, e.g., including a valve with a valve gate movable between open and closed positions and/or a motor-driven metering wheel that can be rotated to deliver controlled amounts of powder material, may control flow of powder material from the powder supply 14 to the preload container 10. A dispense mechanism 30 may be provided at an outlet end of the preload container 10 and be configured to control flow of powder material from the preload container 10 to a recoater hopper 2. In some cases, the preload container 10 and the dispense mechanism 30 may be configured to rapidly transfer a predetermined amount of powder material from the preload container 10 to the recoater hopper 2. In some cases, an entire volume of powder material held by the preload container 10 may be transferred to the recoater hopper 2, e.g., so that the preload container 10 is emptied of powder material in a single, rapid operation.

The preload container 10 may be filled with powder material by closing or otherwise operating the dispense mechanism 30 to prevent exit of powder material from the preload container 10. Powder material may then be supplied from the powder supply 14 into the preload container 10, e.g., by suitably operating the supply mechanism 28. In some embodiments, a predetermined amount of powder material may be provided to and held by the preload container 10, e.g., a predetermined volume and/or mass of powder material may be supplied to and held by the preload container 10. The time needed to fill the preload container 10 with the predetermined amount of powder material may take relatively long, e.g., 30 seconds or more, a few minutes or more, etc., although this is not required The fill time of the preload container 10 may not be critical or otherwise limit the overall speed of the print operation, e.g., because the recoater hopper 2 may be positioned away from the preload container 10 during filling of the preload container 10. With the preload container 10 holding the predetermined amount of powder material, the recoater hopper 2 may be coupled to the outlet of the preload container 10 and the dispense mechanism 30 operated to deliver the entire predetermined amount of powder material to the recoater hopper 2, e.g., in a time less than 10 seconds and/or under the force of gravity. For example, the dispense mechanism 30 may include a valve with a movable gate or other element that can be opened to permit the predetermined amount of powder material to fall by gravity into the recoater hopper 2. By transferring the entire amount of powder material held by the preload container 10, the system can be ensured that a specific amount of powder material is received by the recoater hopper 2, which may avoid any need to closely monitor or control the transfer of powder to the recoater hopper 2. This transfer may be relatively fast and require the recoater hopper 2 to be stopped for filling with powder material for only a short time. Moreover, because the preload container 10 can be filled with a controlled amount of powder, an accurate amount of powder material may be delivered to the recoater hopper 2 in rapid fashion, ensuring that a known number of powder material layers may be formed by the recoater hopper 2 for each fill operation.

In some cases, a seal 12 may be provided to provide an interface between an outlet of the preload container 10 and an inlet 26 of the recoater hopper 2. The seal 12 may provide a fluid-tight or otherwise sealed interface between the preload container 10 and the inlet 26 to prevent or otherwise resist exit of powder material at the junction between the preload container 10 and the inlet 26. In some cases, a space of the recoater hopper 2 that received powder material may be enclosed so as to resist unwanted exit of powder material, e.g., in dust form. Thus, release of powder material during filling of the recoater hopper 2 may be prevented or otherwise limited to nothing or a relatively small amount. Components of the seal 12 may be carried by the preload container 10 and/or the inlet 26 and may permit the recoater hopper 2 to be moved away from a fill position, e.g., shown in FIG. 1, to other positions relative to the build surface 3, e.g., to deposit a layer of powder material. Thus, the powder supply system 9 may be positioned away from a build surface 3 or otherwise in a convenient location so as to not interfere with movement of the recoater hopper 2 and/or other components of the system 11 such as the optics assembly 17. In some cases, the inlet 26 may be configured at an angle relative to vertical, e.g., 45 degrees or less relative to vertical such that the portion of the inlet 26 that interfaces with the seal 12 and/or the preload container 10 can be positioned further away from the build surface 3 or other area than the interfacing portion of the inlet 26. For example, the inlet 26 may include a tube that extends at a 45 degree or other suitable angle away from the recoater hopper body. This may allow the inlet 26 to reach areas offset from the recoater hopper body and further permit the powder supply system 9 to be positioned away from movement areas of the additive manufacturing system 11 or otherwise in a convenient location.

In some embodiments, the powder supply system 9 may be configured to transfer powder material from the powder supply 14 to the preload container 10 and/or from the preload container 10 to the recoater hopper 2 while the powder material is an isolated environment, e.g., an environment that is purged of air or other unwanted gasses and instead flooded with inert gas such as argon. Powder material may be provided to the powder supply system 9 from areas outside of a printer enclosure or other enclosed space in which the powder supply system 9 is located. That is, a printer enclosure in which the printed part is formed and where the powder supply system 9 is located may be purged of air or other unwanted gases, e.g., to help reduce oxidation or other problems with a printed part and/or the powder material. However, because of the relatively large amounts of powder material that may be needed to form a printed part, the powder material may need to be provided from areas outside of the sealed and purged printer enclosure. Thus, a transport mechanism, such as auger feed, pneumatic delivery and/or conveyor used to transport powder material to the powder supply system 9 may introduce air or other gases into the printer enclosure or at least into the feed conduit to the powder supply system 9. In some embodiments, the powder supply and/or preload container may provide an isolated environment for powder material. Spaces holding powder material may be purged with an inert gas, e.g., argon, which can prevent any metallic powder materials from oxidizing and/or minimizing the explosivity of any powder fusion reactions. As such, the powder material is maintained in an isolated environment even during transfer of the powder material, e.g., from the powder supply to the preload container and from the preload container to the recoater hopper, to prevent any oxidation of the powder material which may cause quality issues in a resulting print.

In some embodiments, to provide an isolated environment for powder material, the powder supply system 9 may include a purging gas inlet 22 to receive argon or other purging gas and a gas outlet 23 to allow purged gases to escape the powder supply system 9. The gas inlet 22 may be provided at a location between the preload container 10 and the powder supply 14 (e.g., between the supply mechanism 28 and the powder supply 14) and/or may be positioned at a location below an upper level of powder material held in the powder supply 14. In some cases, purging gas received at the gas inlet 22 may pass through the powder material in the powder supply, e.g., so as to form a type of fluidized bed in the powder material to help remove unwanted gasses. The gas outlet 23 may be located on the powder supply 14, e.g., on a wall of the container of the powder supply 14, or may be located more distant from the powder supply 14, e.g., on a portion of the transport conduit or system used to deliver powder material to the inlet 24 of the powder supply 14. This more distant location may help purge areas of the transport mechanism and improve the characteristics of the isolated environment in the powder supply system 9. The gas outlet 23 may be positioned above an upper level of powder material in the powder supply 14. Purging gas received at the gas inlet 22 may also help purge the preload container 10 so that powder material held in the preload container 10 and transferred to the recoater hopper 2 is in an isolated environment.

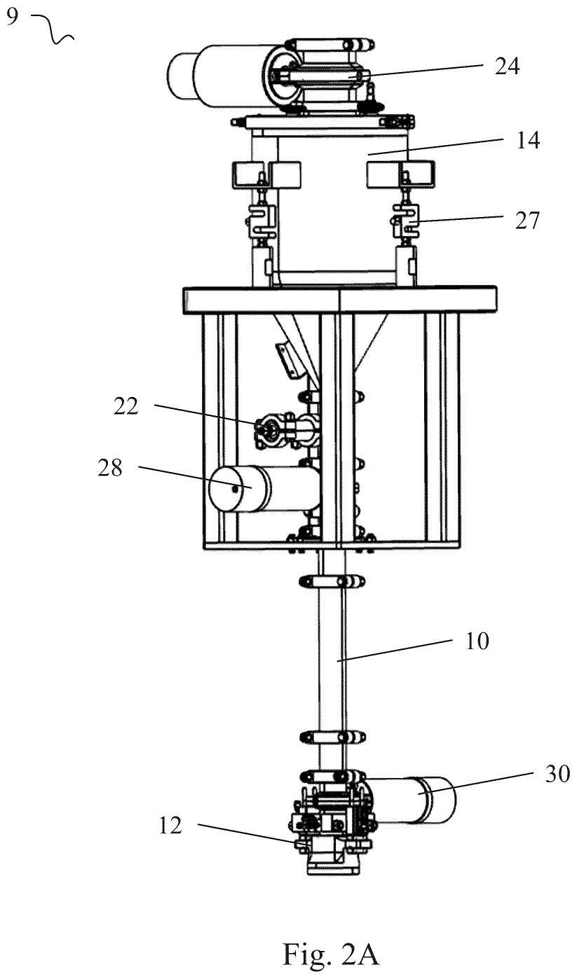

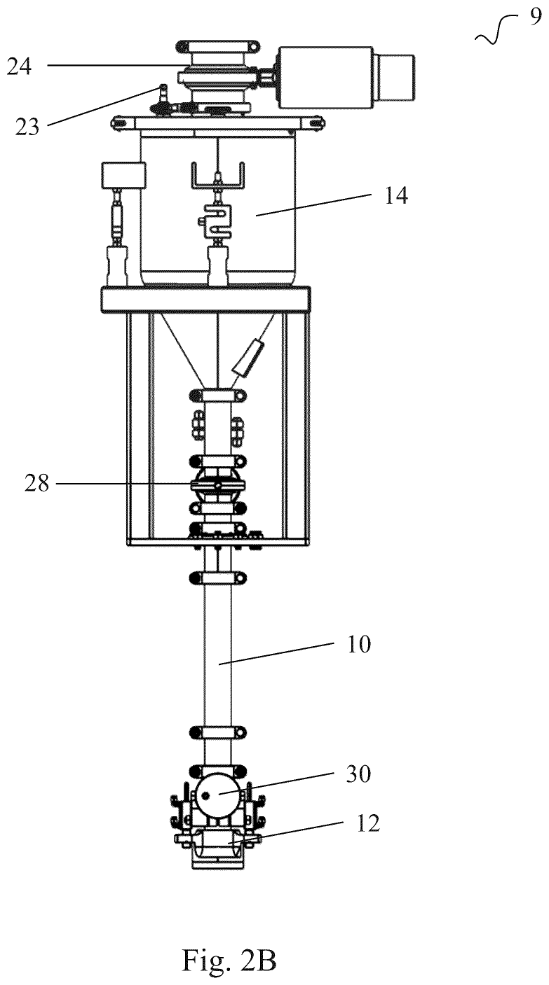

FIGS. 2A and 2B show more detailed views of a powder supply system 9 in some embodiments. The powder supply 14 may be positioned vertically above the preload container 10, which may be positioned vertically above the dispense mechanism 30 and/or the seal 12. Thus, the powder supply 14 and preload container 10 may be configured so that powder material may be received into the powder supply 14 via gravity through the inlet 24, may be moved from the powder supply 14 via gravity into the preload container 10, and/or may be moved from the preload container 10 to the recoater hopper 2 via gravity. Such gravity feed, although not required for all aspects of powder movement in the powder supply system 9, may help simplify mechanisms needed to effect powder movement. The powder supply system 9 may remain stationary relative the recoater hopper 2 and/or other portions of the additive manufacturing system 11, and the recoater hopper 2 may move to a refill position so the inlet 26 interfaces with the seal 12 to receive powder material from the preload container 10.

As can be seen in FIG. 2A, the supply mechanism 28 can include a motor-operated valve, metering wheel, auger or other component configured to control flow of powder material to the preload container 10, e.g., under the control of the controller 18. As noted above, the preload container 10 may be provided with a predetermined amount of powder material, e.g., a predefined mass and/or volume of powder material for later delivery to the recoater hopper 2. This may permit the preload container 10 to provide a specific amount of powder material to the recoater hopper 2 in a way that does not require detailed control of the transfer of powder material from the preload container 10 to the recoater hopper 2. Thus, an entire amount of powder material held by the preload container may be transferred to the recoater hopper 2 such that the preload container 10 is completely empty of powder material. This type of transfer need have no specific control as the entire charge of powder may be dumped or simply transferred to the recoater hopper. Instead, only supply of powder material to the preload container 10 need be closely controlled to the extent the amount of powdered material transferred to the recoater hopper 2 must be accurate.

In some embodiments, the amount of powder material present within the preload container can be determined by a change in the amount of powder material in the powder supply. One or more sensors 27 may be employed by the controller 18 to control delivery of powder material to the preload container 10. For example, the supply mechanism 28 may be operated to supply powder material to the preload container 10 (e.g., by opening a valve and/or turning a metering wheel) while one or more sensors 27 detects and reports to the controller 18 one or more characteristics of the powder material delivered to the preload container 10. For example, in some embodiments a sensor 27 may detect a change in weight of and/or empty volume of and/or level of powder material in the powder supply 14 as powder is delivered to the preload container 10. When a predetermined mass or volume of powder material is provided to the preload container 10, e.g., as determined based on information from a sensor 27, the controller 18 may cause the supply mechanism 28 to stop powder delivery (e.g., by closing a valve, stopping rotation of a metering wheel, stopping movement of an auger, etc.). In some embodiments, a sensor 27 may detect a change in weight of the preload container 10 and/or a fill level of powder material in the preload container 10 and provide this information to the controller 18 which may control the supply mechanism 28 accordingly. For example, a sensor 27 may optically, acoustically, capacitively and/or otherwise detect a fill level of powder material in the preload container 10 to determine whether the predetermined amount of powder material has been received by the preload container 10. These and/or other techniques may be employed to control delivery of powder material to the preload container 10 so that a suitable predetermined amount of powder material is held by the preload container 10 for transfer to a recoater hopper 2. In some embodiments, powder material delivery to the preload container 10 may be done in an uncontrolled and/or open loop controlled way. For example, the controller 18 may cause the supply mechanism 28 to permit powder delivery for a period of time, after which the supply mechanism 28 stops powder delivery. This may be done by opening a valve for period of time, and then closing the valve, and/or operating a metering wheel, auger, or other delivery mechanism for a period of time. Thus, the predetermined amount of powder material need not necessarily be a closely controlled mass and/or volume of material in all cases. The fill process of the preload container 10 with the predetermined amount of powder material may take a relatively long period of time, e.g., 30 seconds or more, 1 minute or more, several minutes or more, etc., and may be substantially longer than a time needed to transfer the predetermined amount of powder material to the recoater hopper 2.

With the preload container 10 charged with a predetermined amount of powder material, the powder material can be transferred to a recoater hopper 2. To do so, the inlet 26 of a recoater hopper 2 may be interfaced with the seal 12 or other outlet of the preload container 10 (e.g., where the seal 12 is carried by the recoater hopper 2) and the dispense mechanism 30 operated by the controller 18 to transfer the powder material. For example, the dispense mechanism 30 may include a valve with a movable valve gate or other element that can be opened to permit powder material to fall from the preload container 10 into the inlet 26 of the recoater hopper 2. Transfer of the predetermined amount of powder material to the recoater hopper 2 may be accomplished solely or at least in part by gravity. In some cases, transfer of the predetermined amount of powder material may be completed in a relatively short period of time, such as 20 seconds or less, 10 seconds or less, 5 seconds or less, etc. Venting of the preload container 10 during transfer of the predetermined amount of powder material may not be necessary, e.g., gas needed to take the place of powder material that exits the preload container 10 may flow upwardly from the recoater hopper 2 and into the preload container 10 as powder material flows downwardly. In some cases, gas may be delivered to the preload container 10, e.g., near a top of the preload container 10 during powder transfer. This may be done using the gas inlet 22 or other gas inlet to the preload container 10. In some cases, powder material transferred into the recoater hopper 2 may be moved in the recoater hopper 2, e.g., by an auger or other device to make space for additional incoming powder material. The predetermined amount of powder material may be a relatively large amount, such as an amount needed to form 10 to 30 or more layers of powder material on the build surface 3. This may permit an extended period of time between needed refills of the recoater hopper 2. Since an amount of powder material transferred to the recoater hopper 2 may be accurately defined, there can be confidence that the recoater hopper 2 will have enough powder material to form at least a particular number of layers on the build surface.

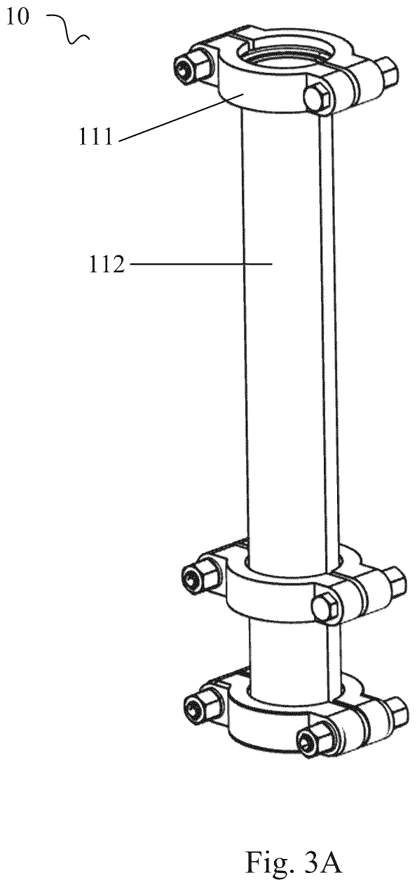

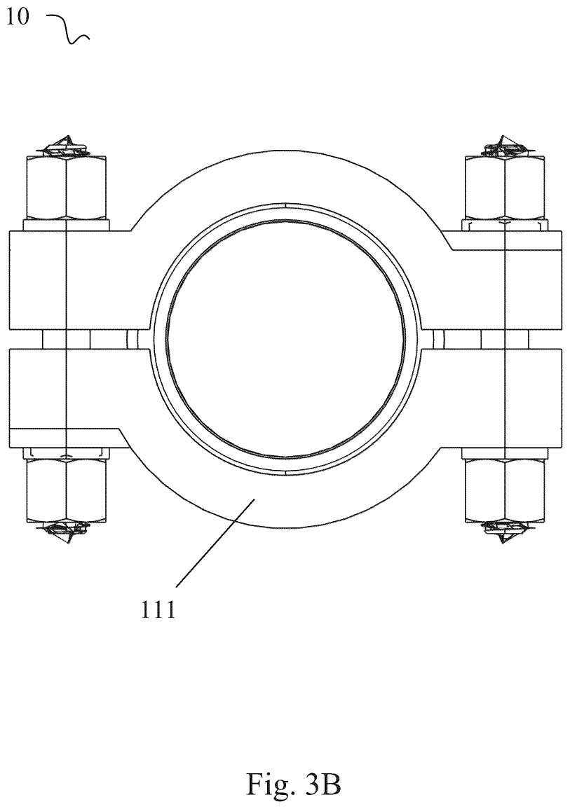

FIGS. 3A and 3B depict a portion of a preload container 10, e.g., which extends between the supply mechanism 28 and the dispense mechanism 30. The preload container 10 may be configured to hold a predetermined amount of powder material, e.g., include a tubular component such as a cylindrical tube having an inner volume that corresponds to a predetermined amount of powder material or is otherwise suitable to hold a predetermined amount of powder material. The preload container 10 may be configured such that the powder material can be moved into the preload container 10, and/or out of the preload container 10 and into a recoater hopper 2 with only a force of gravity. In some embodiments, a longitudinal axis of the preload container 10, e.g., a longitudinal axis of an elongated tube or other structure, may be suitably oriented with respect to local gravitational field lines, e.g., at an angle of 45 degrees of less to a vertical direction or axis. A preload container suitably oriented relative to a vertical direction can increase a speed of transfer and/or reduce a time of transfer of the powder material. In some cases, the preload container may include one or more cylindrical or otherwise tubular segments 112 that are joined together, e.g., sealingly joined, using tri-clamp structure or other suitable couplings 111. Interior portions of the preload container may have suitably smooth or otherwise configured surfaces to encourage powder flow, e.g., the interior surfaces of the preload container may lack edges, corners, and/or crevices which may trap or otherwise impede movement of powder material. The interior space of the preload container 10 may be sealed from an external environment, e.g., so the powder material can be held in an isolated environment and/or so that powder material does not exit the interior space in an unwanted way (e.g., to avoid forming a cloud or otherwise airborne amount of powder material that may settle on the build surface or elsewhere).

In some embodiments, a seal 12 may be provided between an outlet of the preload container 10 and the inlet 26 of the recoater hopper 2, and may be connected to the outlet of the preload container 10 and/or the inlet 26 of the recoater hopper 2. The seal 12 may provide an interface between the outlet of the preload container 10 and the inlet 26, e.g., to keep powder material contained in the closed space of the preload container 10 and the recoater hopper 2. The seal 12 may have a changeable shape, e.g., through either an active engagement and/or a passive engagement, such that the seal is able to conform to or otherwise interface with the outlet of the preload container and/or the inlet 26 of the recoater hopper. The seal 12 may be passive, e.g., be configured to interface with the outlet of the preload container 10 and the inlet 26 without any controllably movable parts. For example, the seal 12 may include one or more resilient components, such as an o-ring or rubber gasket configured to form a seal with the preload container outlet and the inlet 26 when the recoater hopper 2 is positioned at a refill location. The seal 12 may be carried on the preload container outlet and/or or the inlet 26, e.g., resilient gaskets on either or both of the preload container outlet and the inlet 26 may compliantly engage to form a suitable seal or other interface between the preload container 10 and the recoater hopper 2 when the recoater hopper 2 moves to the refill position.

In some cases, a seal 12 may include one or more movable portions to interface between the outlet of the preload container 10 and the inlet 26. The movable portion may help bridge or otherwise accommodate a gap between the outlet of the preload container 10 and the inlet 26, which may be required to permit the recoater hopper 2 to move away from and to the refill position to receive powder material from the preload container 10. In some examples, the seal 12 may include an inflatable portion, such as an inflatable toroid or cylinder made of or otherwise including a resilient material. The inflatable portion may be capable of expanding in volume, e.g., so one or more wall portions of the inflatable portion stretch to increase its total volume, or may be flexible but not expandable in volume beyond a maximum volume. As an example, a seal 12 having an inflatable portion may be positioned on the outlet of the preload container 10 and when the inlet 26 is positioned near the seal 12, the inflatable portion may be inflated to contact the inlet 26 and form a suitable seal or other interface between the outlet and the inlet. However, this is just one example and a seal having a movable portion may be configured in other ways.

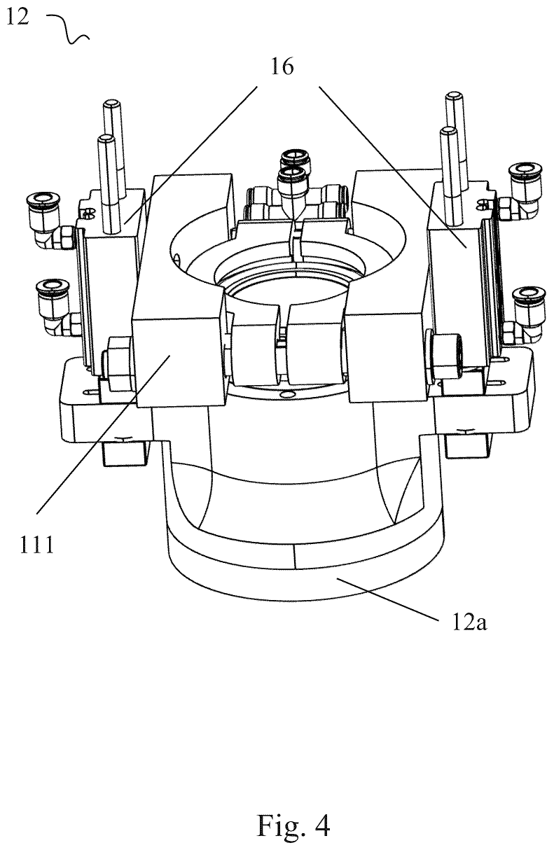

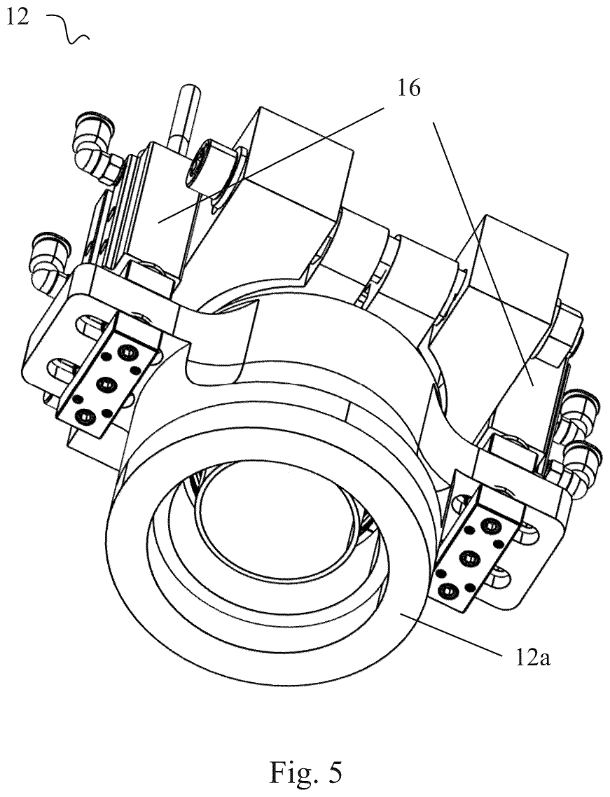

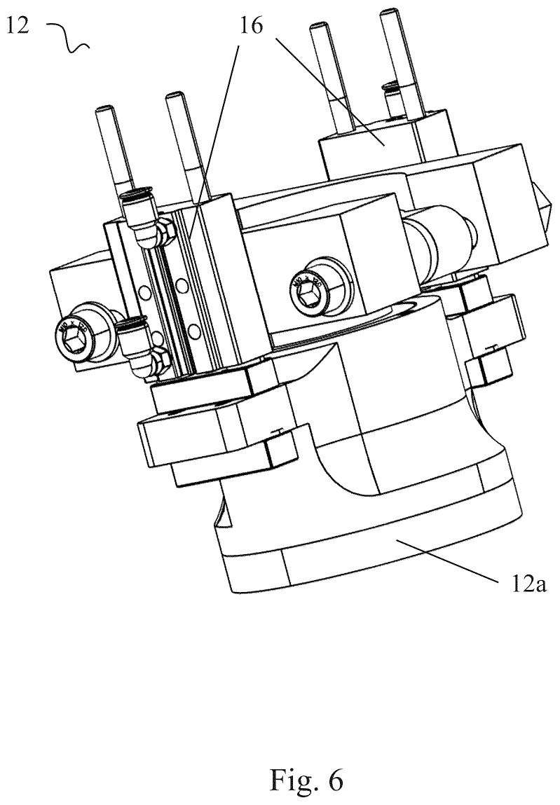

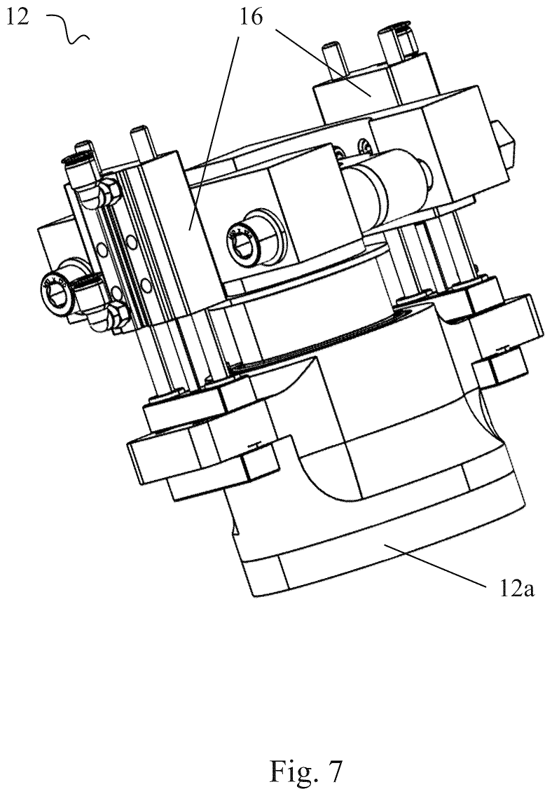

For example, FIGS. 4-7 show a seal 12 having a movable portion 12a that can be moved by one or more actuators 16, such as pneumatically operated cylinders that can be controlled by the controller 18. Other types of actuators can be employed including but not limited to electric motors, stepper motors, hydraulic actuators, pneumatic actuators, electric actuators, and/or any other appropriate type of actuator as the disclosure is not so limited. FIGS. 4-6 show the seal 12 in a retracted state with the actuators 16 in a retracted state, whereas FIG. 7 shows the actuators 16 in an extended state and the movable portion 12a extended downwardly. For example, before the recoater hopper 2 is moved to a refill position, the seal 12 may be configured so the movable portion 12a is in a retracted state, e.g., allowing the inlet 26 of the recoater hopper 2 to be moved to a position below the seal 12 without interference. Thereafter, the movable portion 12a may be moved to the extended position, e.g., so a lowermost portion of the movable portion 12a can engage with the inlet 26. A lowermost or leading end of the movable portion 12a may include a resilient gasket or other element to sealingly engage with the inlet 26. e.g., by conforming to one or more parts of the inlet 26 so that that no gas exchange occurs between the external environment and the inner space of the preload container 10 and the inlet 26 of the recoater hopper 2. In some embodiments, the seal 12 may be mounted on a portion of the recoater hopper, such as the inlet 26, and the movable portion 12a of the seal 12 may extend in a direction from the powder inlet of the recoater hopper towards the outlet of the preload container 10. In such an embodiment, the seal may conform to or otherwise engage with the outlet of the preload container, e.g., to maintain an isolated environment for the powder material upon transfer of the powder material from the preload container to the recoater hopper.

In some embodiments, a method of dispensing powder material for an additive manufacturing system includes filling a preload container with a predetermined amount of powder material from a powder supply. This may be done by opening a valve between a powder supply and a preload container or otherwise operating a dispensing mechanism so powder material falls by gravity into or otherwise is provided to the preload container. The predetermined amount of powder may be determined by measuring a volume and/or mass of powder material transferred to the preload container, and may be done by any suitable sensor and/or operation of the dispensing mechanism. When the powder material within the preload container has been determined to reach the predetermined amount, e.g., by information obtained by the controller from one or more sensors and/or by operation time of the dispensing mechanism, the valve at the inlet of the preload container may be closed or the dispensing mechanism otherwise operated so no further powder material is provided to the preload container. The predetermined amount of powder material may be held within the preload container until the recoater hopper needs a powder refill, e.g., when the recoater hopper is close to or has run out of powder material, upon which the recoater hopper may be positioned for refilling by the preload container. At this point, the predetermined amount of powder material may be transferred from the preload container to the recoater hopper, e.g., by opening a valve or otherwise operating a supply mechanism at an outlet of the preload container and allowing the powder material to fall by gravity to the recoater hopper. Transfer of the entire predetermined amount of powder material may occur rapidly, e.g., in 10 seconds or less. After the predetermined amount of powder material is deposited into the recoater hopper, the at least one sensor may indicate that the predetermined amount of powder material has been transferred. Thereafter, the valve at the outlet of the preload container may be closed, and filling of the preload container 10 with a next predetermined amount of powder material may start. By refilling the preload container while the recoater hopper is depositing material on the build surface, the additive manufacturing system can optimize the efficiency as multiple processes are performed simultaneously and the amount of time associated with filling the recoater hopper is significantly reduced compared to continuous refilling systems.

It will be appreciated that any embodiments of the systems, components, methods, and/or programs disclosed herein, or any portion(s) thereof, may be used to form any part suitable for production using additive manufacturing. For example, a method for additively manufacturing one or more parts may, in addition to any other method steps disclosed herein, include the steps of selectively fusing one or more portions of a plurality of layers of precursor material deposited onto the build surface to form the one or more parts. This may be performed in a sequential manner where each layer of precursor material is deposited on the build surface and selected portions of the upper most layer of precursor material is fused to form the individual layers of the one or more parts. This process may be continued until the one or more parts are fully formed.

The various methods or processes outlined herein and/or functions performed by a controller may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein, including implementations of the controller, may be employed as a computer readable storage medium (or multiple computer readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computing devices or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal. A controller may include not only suitable data processing hardware and software or other instructions, but any other components needed or otherwise suitable to perform functions described herein, including power supplies, sensors, actuators, drives or transmissions, relays, etc.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that one or more computer programs that when executed perform methods of the present disclosure need not reside on a single computing device or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A system for dispensing a powder material for an additive manufacturing system, the system comprising:
a powder supply configured to hold the powder material;
a preload container coupled to the powder supply and configured to hold a predetermined amount of powder material received from the powder supply; and
a mechanism to control a flow of the predetermined amount of powder material from the preload container to a recoater hopper of a recoater system, wherein the preload container and the mechanism are configured to deliver the entire predetermined amount of powder material to the recoater hopper such that the preload container is empty of powder material.

2. The system of claim 1, further comprising a sensor configured to detect when the preload container holds the predetermined amount of powder material in the preload container.

3. The system of claim 2, wherein the sensor is configured to optically detect that the preload container holds the predetermined amount of powder material.

4. The system of claim 2, wherein the sensor is configured to detect a mass of powder material in the preload container.

5. The system of claim 1, wherein the mechanism includes a valve that is movable between open and closed positions.

6. The system of claim 1, wherein the powder supply includes a hopper positioned vertically above and fluidly coupled to the preload container.

7. The system of claim 6, wherein the hopper is configured to deliver the powder material to the preload container via gravity.

8. The system of claim 7, further comprising a valve to control movement of the powder material from the hopper to the preload container.

9. The system of claim 1, further comprising a valve to control movement of the powder material from the powder supply to the preload container.

10. The system of claim 9, wherein the powder supply and the preload container are configured to deliver the powder material from the powder supply to the preload container by gravity.

11. The system of claim 1, wherein the preload container has a tubular shape.

12. The system of claim 1, further comprising a controller configured to determine that the preload container holds the predetermined amount of powder material based on a volume of powder material in the preload container or a weight of powder material in the preload container.

13. The system of claim 1, wherein the preload container and the mechanism are configured to transfer the predetermined amount of the powder material from the preload container toward the recoater hopper in 10 seconds or less.

14. The system of claim 1, wherein the predetermined amount of powder material comprises sufficient powder material for depositing 10 to 30 layers of powder material on a build surface of the additive manufacturing system.

15. The system of claim 1, wherein the preload container includes an elongated tube with a longitudinal axis that holds the predetermined amount of powder material, the longitudinal axis oriented at an angle of 45 degrees or less from a vertical axis.

16. The system of claim 1, wherein the preload container and the mechanism are configured to permit a flow of the predetermined amount of the powder material from the preload container to the recoater hopper based solely on gravity.

17. A method of dispensing powder material for an additive manufacturing system, the method comprising:
filling a preload container with a predetermined amount of powder material from a powder supply; and
transferring the predetermined amount of powder material from the preload container to a recoater hopper such that the preload container is emptied of powder material.

18. The method of claim 17, wherein filling the preload container includes providing the powder material from the powder supply to the preload container until the preload container holds a predetermined volume or mass of powder material.

19. The method of claim 18, wherein filling the preload container includes using a sensor to measure a volume or mass of powder material in the preload container and stopping providing the powder material from the powder supply to the preload container when the volume or mass of powder is equal to a predetermined volume or mass of powder material.

20. The method of claim 17, wherein filling the preload container includes permitting the powder material to fall under the force of gravity into the preload container.

21. The method of claim 20, wherein filling the preload container includes opening a valve positioned at an entrance to the preload container to permit the powder material to fall into the preload container.

22. The method of claim 17, wherein filling the preload container includes filling a tubular portion of the preload container with the predetermined amount of the powder material.

23. The method of claim 17, wherein filling the preload container includes moving the predetermined amount of powder material from a powder supply to the preload container while the predetermined amount of powder material is held in an isolated environment.

24. The method of claim 23, wherein the isolated environment is an environment purged with inert gas.

25. The method of claim 17, wherein transferring the powder material from the preload container comprises transferring the powder material solely under the force of gravity.

26. The method of claim 25, wherein transferring the powder material from the preload container comprises opening a valve to permit the predetermined amount of powder material to fall from the preload container under the force of gravity.

27. The method of claim 17, wherein transferring the powder material from the preload container includes emptying the preload container of the predetermined amount of powder material in less than 10 seconds.

28. The method of claim 17, wherein the predetermined amount of powder material is suitable to form 10 layers or more of powder material on a build surface of the additive manufacturing system.

29. The method of claim 17, wherein transferring the powder material includes transferring the predetermined amount of powder material to the recoater hopper without releasing any of the predetermined amount of powder material into an environment around the preload container and the recoater hopper.

30. The method of claim 29, wherein transferring the powder material includes sealing an outlet of the preload container with an inlet of the recoater hopper.

31. A system for dispensing a powder material for an additive manufacturing system, the system comprising:
a powder supply holding the powder material; and
a preload container coupled to the powder supply, the powder supply and the preload container being configured to transfer powder material from the powder supply to the preload container in an isolated environment.

32.-39. (canceled)

40. A method of dispensing powder material, the method comprising:
providing powder material in an isolated environment within a powder supply;
transferring the powder material from the powder supply to a preload container; and
maintaining the powder material within the isolated environment during transfer of the powder material to the preload container.

41.-49. (canceled)

50. A system for dispensing a powder material for an additive manufacturing system, the system comprising:
a powder supply holding the powder material and comprising a powder outlet;
a recoater hopper having a powder inlet configured to receive the powder material from the powder outlet; and
a seal including a movable portion configured to interface between the powder inlet and the powder outlet, wherein the movable portion is configured to move to engage with the powder inlet or the powder outlet to provide a fluid connection between the powder inlet and the powder outlet.

51.-60. (canceled)
